(19) United States
(12) Patent Application Publication
(10) Pub. No.: US 2026/0279151 A1
(43) Pub. Date: Sep. 17, 2026

(54) Systems and Methods for Generating Analytics for Casino Gaming Tables

(71) Applicant: Tavolo Intellect LLC, Grosse Pointe, MI (US)

(72) Inventors: Ryan Patrick McClellan, Grosse Pointe, MI (US); Evan Andrew Juras, Bozeman, MT (US); Mark Bedair Wassef, Hoboken, NJ (US)

(21) Appl. No.: 19/449,717

(22) Filed: Jan. 15, 2026

Related U.S. Application Data
(60) Provisional application No. 63/745,383, filed on Jan. 15, 2025.

(51) Int. Cl. G07F 17/32

(52) U.S. Cl. CPC G07F 17/3241; G07F 17/3223

(57) ABSTRACT

A system and method of generating analytics relating to casino gaming activity at a gaming table in a casino, the method includes analyzing, on a surveillance network that includes one or more detection devices, camera data generated by the one or more detection devices by running at least one model executed on the surveillance network to generate model output data representative of detected gaming objects and/or activity associated with the casino gaming activity; transmitting the model output data from the surveillance network to a property network at the casino, the property network being a separate network from the surveillance network; and processing, by one or more computing devices on the property network, the model output data to infer gaming events or performance metrics and generate the analytics relating to the casino gaming activity.

### CROSS-REFERENCE TO RELATED APPLICATIONS

This application claims priority to US 63/745,383 filed on Jan. 15, 2025, the entirety of which is hereby incorporated by reference herein for all purposes.

### FIELD

These teachings relate generally to systems and methods for generating analytics associated with casino gaming activity at casino gaming tables.

### BACKGROUND

Analyzing casino game play at casinos is becoming more important as casinos look to obtain analytics and insights about player betting behavior, utilization of gaming tables, and/or obtaining operational performance metrics such as the number of hands dealt by a dealer within a given time period.

Accordingly, there is a need to improve the current state in the art for obtaining, processing, and/or communicating and interpreting data for casino gaming analytics.

### SUMMARY

These teachings relate to systems and methods for generating analytics associated with casino gaming activity at a casino or casino gaming tables.

A method of generating analytics relating to casino gaming activity at a gaming table in a casino, the method comprising: analyzing, on a surveillance network that includes one or more detection devices, camera data generated by the one or more detection devices by running at least one model executed on the surveillance network to generate model output data representative of detected gaming objects and/or activity associated with the casino gaming activity; transmitting the model output data from the surveillance network to a property network at the casino, the property network being a separate network from the surveillance network; and

processing, by one or more computing devices on the property or site network, the model output data to infer gaming events or performance metrics and generate the analytics relating to the casino gaming activity.

A system for generating analytics relating to casino gaming activity at a gaming table in a casino, the system comprising: a first network comprising one or more detection devices configured to generate camera data of the gaming table; one or more computing devices operatively connected to or executed on the first network and configured to execute at least one model on the camera data to generate model output data representative of detected objects and/or activity associated with the casino gaming activity; a second network at the casino that is separate from the first network; one or more computing devices operatively connected to the second network; and a communication interface configured to transmit the model output data from the first network to the second network; wherein the one or more computing devices on the second network are configured to process the model output data to infer gaming events or performance metrics and to generate analytics relating to the casino gaming activity.

### BRIEF DESCRIPTION OF THE DRAWINGS

FIG. 1 is a schematic view of an exemplary casino gaming table configured for use with the systems and methods described herein.

FIG. 2 is a block diagram illustrating exemplary hardware components of a system described herein.

FIG. 3A is a block diagram illustrating exemplary hardware components of a system described herein.

FIG. 3B is a block diagram illustrating a method associated with the system of FIG. 3A.

FIG. 4A is a block diagram illustrating exemplary hardware components of a system described herein.

FIG. 4B is a block diagram illustrating a method associated with the system of FIG. 4A.

FIG. 5 is a block diagram illustrating exemplary hardware components of a system configured to perform the methods described herein.

FIG. 6 is a block diagram illustrating exemplary hardware components of a system configured to perform the methods described herein.

FIG. 7 is a block diagram illustrating exemplary hardware components of a system configured to perform the methods described herein.

### DETAILED DESCRIPTION

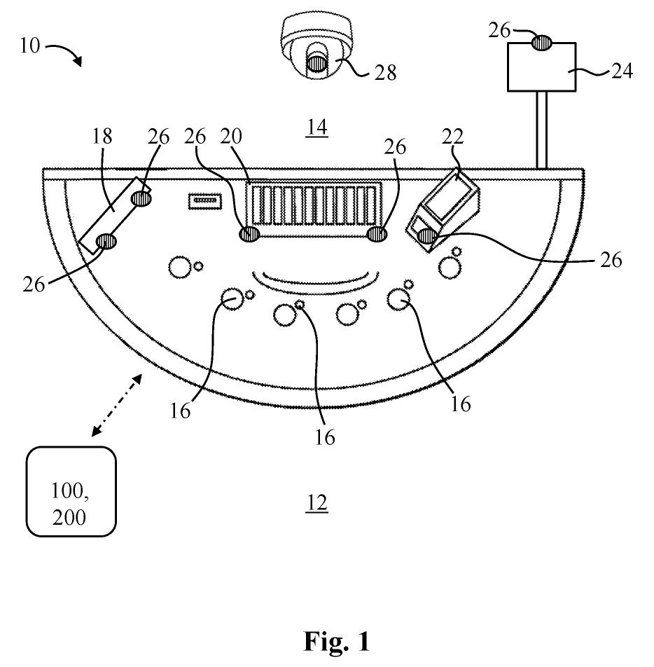

FIG. 1 illustrates a gaming table 10. The gaming table 10 may be located in a gaming facility or venue such as a casino, hotel, etc. A casino game such as blackjack, roulette, baccarat, craps, pai gow, etc., may be played at the gaming table 10. The present teachings may also be relevant to other casino gaming tables or devices for which it may be desirable to obtain or generate analytics, such as electronic gaming machines like slot machines, poker machines, keno machines, etc. In some instances, the teachings herein can be applied to connecting, transmitting, and/or processing data or information between two or more devices on different servers or networks.

Generally, the casino gaming table 10 comprises a player area 12 and a dealer area 14. The player area 12 comprises one or more betting regions 16 at which one or more players can place bets during game play.

At the dealer area 14, at which a casino dealer and/or casino staff are positioned during game play, the gaming table 10 may comprise one or more table signs 18, a chip tray 20 containing gaming chips, a card shoe 22 containing playing cards, and/or one or more elevated table or tower signs 24.

One or more detection devices 26 may be used to monitor game play at the gaming table 10. The one or more detection devices 26 may be one or more cameras. The one or more cameras may have fixed imaging characteristics or may have pan-tilt-zoom (PTZ) imaging capabilities.

The one or more detection devices 26 may be mounted, added, provided, integrated, and/or incorporated into, one or more elements of the gaming table 10, that are selected from a group consisting essentially of: the gaming table 10 itself, one or more table signs 18, a chip tray 20, a card shoe 22, an elevated table or tower sign 24, a discard rack, the like, or a combination thereof. A detection device 26 may be part of a casino surveillance system (e.g., a surveillance detection device). A detection device 26 may not be part of a casino surveillance system.

The one or more detection devices 26 may be configured to generate camera data. The camera data may be a video or still image of one or more gaming regions on the gaming table (e.g., betting regions, the table, felt, etc.), one or more gaming objects and/or gaming activity associated with game play at or near the casino gaming table 10 and/or body characteristics of a player, dealer, or bystander (e.g., facial recognition, hand or appendage recognition, etc.).

For example, the one or more detection devices 26 may be configured to generate camera data of gaming objects like: playing cards, gaming chips, card shufflers, discard racks, cut cards, currency, dice, loyalty cards, cashless tickets, vouchers, or coupons (e.g., TITO tickets), the like, or any combination thereof.

For example, the one or more detection devices 26 may be configured to generate camera data of activity associated with casino gaming at or near the gaming table 10 such as: a player making a buy-in or cash out; a player making various hand signals (hold, hit, etc.), a player leaving a gaming table, a player approaching a gaming table, a casino dealer dealing cards, a casino dealer collecting cards, a casino dealer making a payout, a casino dealer collecting payment, the like, or any combination thereof.

The camera data may comprise live or near-live image and/or video data captured before, during, and/or after game play at the gaming table.

The facility or venue in which the gaming table 10 is located may include one or more detection devices 28. The one or more detection devices 28 may form or be part of a casino surveillance system. Such detection devices 28 are typically accessible to personnel responsible for monitoring game integrity, regulatory compliance, and/or casino security and surveillance. Such detection devices may also be referred to herein as a surveillance detection devices.

A detection device 28 may be located at or near a gaming table. A detection device 28 may be located or positioned above or elevated relative to the gaming table 10. A detection device 28 may be mounted to a wall, ceiling, or other structure within the facility. In some embodiments, a detection device 28 may be positioned directly overhead of the gaming table 10. In some embodiments, a detection device 28 may be at an overhead angle relative to the gaming table 10. A detection device 28 may be a camera. A detection device 28 may be an overhead camera. A detection device 28 or camera may include pan-tilt-zoom (PTZ) capabilities or may have fixed imaging characteristics.

The one or more detection devices 28 may be configured to generate camera data. The camera data may be a video or still image of one or more gaming regions on the gaming table (e.g., betting regions, the table, felt, etc.), one or more gaming objects and/or gaming activity associated with game play at or near the casino gaming table 10 and/or body characteristics of a player, dealer, or bystander (e.g., facial recognition, hand or appendage recognition, etc.).

For example, the one or more detection devices 28 may be configured to generate camera data of gaming objects like: playing cards, gaming chips, card shufflers, discard racks, cut cards, currency, dice, loyalty cards, cashless tickets, vouchers, or coupons (e.g., TITO tickets), the like, or any combination thereof.

For example, the one or more detection devices 28 may be configured to generate camera data of activity associated with casino gaming at or near the gaming table 10 such as: a player making a buy-in or cash out; a player making various hand signals (hold, hit, etc.), a player leaving a gaming table, a player approaching a gaming table, a casino dealer dealing cards, a casino dealer collecting cards, a casino dealer making a payout, a casino dealer collecting payment, the like, or any combination thereof.

The camera data from the one or more detection devices 28 may be or comprise live or near-live image and/or video data captured before, during, and/or after game play at the gaming table.

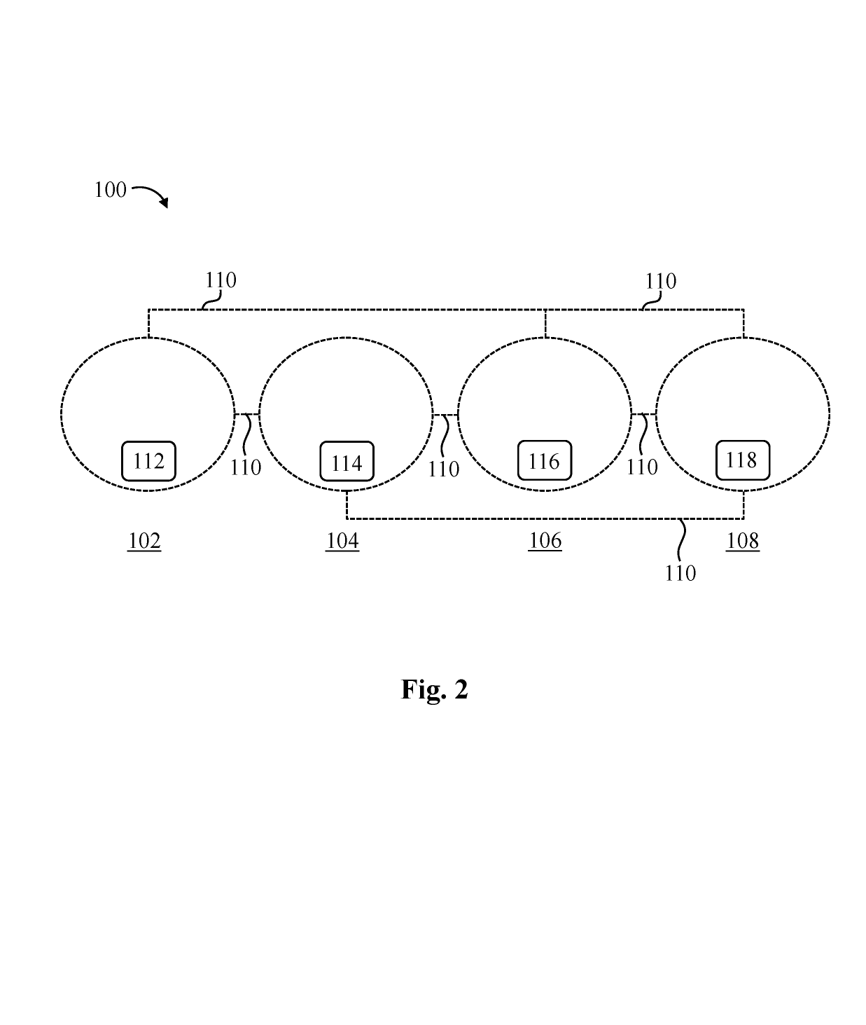

FIG. 2 is a block diagram that depicts exemplary hardware of the system 100 according to these teachings. The system 100 may be for generating analytics relating to casino gaming activity at a gaming table 10 in a casino.

The system 100 and/or method described herein may comprise or utilize two or more networks. The networks may include a first network 102, a second network 104, a third network, 106, a fourth network 108, etc. It is understood that use of terms ‘first’, ‘second’, ‘third’, and ‘fourth’ network is strictly to refer to the different networks and is not otherwise limiting with respect to order, positioning, placement, etc.

The networks 102, 104, 106, 108 may be a cloud network, a surveillance network, a property network or site network or on-site network, and a table network. In some instances, the system 100 may include two networks (e.g., a surveillance network and a property network, or a surveillance network and a table network, or a cloud network and a surveillance network, or a cloud network and a property network, or a cloud network and a table network, or a property network and a table network ). In some instances, the system 100 may include three networks. In some instances, the system 100 may include the four networks. It is to be understood that two or more of the networks described herein may be combined into a single network, a network may be omitted, duplicated, etc.

The networks may be separate and distinct networks. The networks may be electrically connected together via one or more communication protocols to allow for data, signal, and/or information transfer between the networks and/or processors, servers, computers, etc. in the networks. A network may comprise a communication infrastructure, interface, or link 110 that functions or enables information, data, and/or signals to move or be transmitted between the networks and/or two or more servers or computing devices on different networks. The communication infrastructure, interface, or link between the networks may be unidirectional (single direction) or bidirectional. The communication infrastructure, interface, or link between the networks may be a wired or wireless device.

A cloud network may be a network that is located offsite or remote or in a different location from the physical venue or facility in which the gaming table is located.

A surveillance network may be located at the casino venue or facility, or in some instances, may be a remote or cloud network located offsite or remove from the casino venue. A surveillance network may be a restricted or “black box” network. A surveillance network may be hidden or isolated and accessible only to authorized individuals and/or authorized devices having appropriate credentials associated with, for example, casino management, operations, compliance, and/or surveillance. Typically, one or more surveillance detection devices 28, such as cameras used for casino security and game integrity, are located on the surveillance network. Typically, only individuals, staff and/or devices associated with casino security and/or surveillance are provided with camera data or output streams (e.g., still images and/or video camera feed) from the detection devices 28 on the surveillance network. This restriction on access to the surveillance network and/or the associated detection devices 28 and/or the associated camera data from the surveillance detection devices 28 may help reduce or prevent unauthorized access to information or detection devices 28 that may give certain casino patrons or players an advantage at the table game. Such an advantage might mean advantage play as a result of card counting. If the count is in a player’s favor, thus the odds are better for the player, a player may sit down at the table and wager more with a higher win percentage.

A property network or site network or on-site network, which may be used interchangeably unless otherwise noted, may be a network that is located on site at the casino facility. A property network may be or may comprise a local network located at a casino facility. A property network may be a local network at the casino facility used for communicating information to/from/between one or more casino devices used for casino operations and/or game play. For example, one or more casino devices on the property network may be or may include one or more computers, laptops, tablets, printers, gaming tables, slot machines, TITO machines (ticket-in-ticket-out), detection devices, automated teller machines (ATM’s), table computer or processors, analysis servers, televisions, and the like. A property network may be a separate network from the cloud network, surveillance network, and/or table network.

In some embodiments, a property network does not include direct access to the internet. However, some property networks may include internet access, possibly via a gateway or other controlled interface. A property network is typically not accessible by the general public and/or patrons of the casino. In some jurisdictions, a casino surveillance and/or management team may have access to the property network. In some configurations, the property network may provide a communication interface or protocol for communicating or facilitating data communication between one or more devices on the surveillance network, one or more devices on the property network, and/or one or more devices on the cloud network. For example, the property network may enable one-way or two-way communication between an overhead detection server and a property server. The property network may enable one-way or two-way communication between a cloud server and a property server. The property network and/or property server may provide for 1 or 2-way communication between the cloud network and the surveillance network and the respective servers contained therein.

A table network may be an edge network that is located at or nearby a gaming table. A table network may be separate and distinct from the surveillance network, property network, cloud network, etc. A table network may provide for local processing at the table. A table network may reduce latency due to its location at the table.

The system 100 and/or method described herein may comprise or utilize two or more servers. A server may be, or may comprise, one or more computing devices, processing devices, software instances, interpretation engines, machine learning models or techniques, deep learning models or techniques, etc. A server may perform processing, storage, or computing services (e.g., running models, storing data, generating analytics). A server may be a computing device. A server or computing device may comprise a processing device such as a Neural Processing Unit (NPU), graphics processing unit (GPU), or other accelerator suitable for deep learning and/or machine learning model execution.

A server may comprise a non-transitory computer-readable medium storing instructions is disclosed that, when executed by one or more computing devices, cause the one or more computing devices to perform the method disclosed herein.

The servers may comprise a first server 112, a second server 114 a third server 116, and a fourth server 118. It is understood that use of terms ‘first’, ‘second’, ‘third’, and ‘fourth’ server is strictly to refer to the different servers and is not otherwise limiting with respect to order, positioning, placement, etc. The servers may comprise a cloud server, an overhead detection server, a property server, and a table computer or processor. It is to be understood that one or more of the servers described herein may be combined into a single server, omitted, duplicated, or otherwise rearranged. It is noted that property server, site server, and on-site server may be used interchangeably unless otherwise noted.

A cloud server may refer to a server located remote from a casino facility. A cloud server may be located in or executed on a cloud network. A cloud server may be located in a facility, region, or geographic location that is separate from the casino or gaming venue. In some configurations, the cloud server may be accessible from within the casino facility via the cloud network that is in electronic communication with one or more other servers or networks, including the property network, the property server, the surveillance network, the surveillance server or overhead detection server, the table computer or processor, the table network, or any combination thereof.

An overhead detection server may be a server that is located in or executed on the surveillance network. An overhead detection server may be a server that is located on site at the casino facility and typically accessible only to security personnel of the casino.

A property server may be a server that is located on site at the casino facility. A property server may be located in or executed on the property network. A premise sever may be a server that is located on site at the casino facility and typically accessible only to casino management, staff, operations, and/or surveillance of the casino.

A table computer or processor may be an edge computer or processor that is located at or nearby a gaming table. A table computer or processor may be located at or executed in a table network. A table computer or processor may be an edge computer or processor. In some instances, a table computer or processor may be a server or utilize components of a server.

The system 100 and/or method described herein may comprise or utilize one or more models. A model may be or may comprise an electronic representation, depiction, or template of a casino gaming table and/or one or more gaming elements used at the gaming table or associated with casino gameplay, including gaming elements present on or used in connection with a gaming table before, during, and/or after gameplay.

A model may be or may comprise an electronic representation of one or more of elements selected from a group comprising or consisting essentially of: playing cards, playing card values, playing card suits, gaming chips, gaming chip values or denominations, chip stack heights, currency values, the gaming table, the felt or layout design that is located or printed on the table, one or more betting regions on the felt or gaming table, one or more table signs, a chip tray, a card shoe, one or more cut cards, discard rack, loyalty cards, cashless tickets or coupons e.g, TITO tickets, the like, or a combination thereof. A model may include an electronic depiction or representation of dealer and/or player and/or movements or gestures made by a player or dealer, such as a dealer making a payout or collecting chips or currency, or a player making a gesture to hit, stand, or fold.

A model may include or may be built using machine learning and/or deep learning techniques. A model may comprise machine learning and/or deep learning techniques.

A model may be executed on any of the networks disclosed herein (e.g., the cloud network, surveillance network, property network and/or table network). A model may be executed using one or more hardware accelerators comprising or selected from the group consisting of Graphics Processing Units (GPUs), Tensor Processing Unit (TPUs), and Field-Programmable Gate Arrays (FPGAs).

The system 100 and/or method described herein may comprise or utilize one or more computing devices. A computing device may be configured to process model output data to infer, determine, deduce, conclude, speculate, or hypothesize gaming events or performance metrics and generate the analytics relating to the casino gaming activity.

A computing device may be located on, reside on, or executed on or by one or more of the servers and/or networks described herein. A computing device may comprise one or more software, algorithms, look-up tables, machine learning and/or deep learning techniques. A computing device may be configured to interpret the model output data to infer higher-level game events and performance metrics to determine events and/or activity such as a gaming event or round has started or ended, bet wager amounts or information, hands per hour, player betting behavior, etc., thereby generating analytics related to the casino gaming activity taking place or has taken place.

For instance, if model output data indicates that one or more gaming chips have been placed in a particular wager position and that one or more playing cards are subsequently detected near that wagering position, a computing device can determine or infer that a round of game play has started. Conversely, if the model output data indicates that all playing cards have been removed from the gaming table, the computing device may determine or infer that the round of gameplay has ended. Such analysis that are inferred by the one or more computing devices can be output or transmitted to authorized personnel or systems, such as casino operations, management, security, or other designated recipients.

Generally, as an overview, during operation, one or more detection devices (e.g., detection device 26 and/or 28) may observe gaming elements and/or gaming activity at a gaming table. The one or more detection devices may generate camera data (e.g., still and/or motion video and/or images). The camera data may be provided as, inputted to, supplied, or ran in or through at least one model executed by or on one or more servers or computing devices on the one or more networks to generate model output data. In some implementations, the model may reside on the same network or server that the one or more detection devices are on. In some implementations, the camera data, the model, the model output data, are all processed on the same network, computer, computing device, or a combination thereof. In some implementations, the model may reside on a different network or server that the one or more detection devices are on. In such a case, the camera output data must be sent, transmitted, or provided to the network on which the model resides or is executed on. The model output data may be an electronic representative of the content of the camera data. Once generated, the model output data may be processed by one or more computing devices or interpretation engine to infer, determine, deduce, conclude, speculate, or hypothesize certain gaming events or performance metrics and generate the analytics relating to the casino gaming activity. The model output data may be transferred, output, sent, or provided to another network and server, and subsequently processed by one or more computing devices or interpretation engine to infer, determine, deduce, conclude, speculate, or hypothesize certain gaming events or performance metrics and generate the analytics relating to the casino gaming activity. The model output data may be processed by one or more computing devices or interpretation engine on the same network on which the model output data is generated.

For example, the camera data may include an image or video of a playing card, a gaming chip, and currency. The camera data may be analyzed or run through at least one model executed by or on one or more servers or computing devices on one or more networks to generate model output data. The model output data may include a determination that the playing card is a queen of hearts, the gaming chip has a value of $5.00, and the currency is a United States dollar having a value of $50.00. The model output data may be transferred, output, sent, or provided to another network and server, and subsequently processed by one or more computing devices or interpretation engines to infer, determine, deduce, conclude, speculate, or hypothesize for example, a winning hand, a losing hand, a payout, a buy in, a game beginning, a game ending, etc. The resulting analytics may be provided to casino staff, operations, management, etc. for further analysis, processing, and/or reporting purposes.

For example, the camera data may include an image or video of an individual making a hand gesture. The camera data may be analyzed or run through at least one model executed on a network to output model output data. The model output data may include a determination that the hand gesture is a player communicating a hand signal to the dealer requesting to “hit.” The model output data may be transferred, output, sent, or provided to another network and server, and subsequently processed by one or more computing devices or interpretation engine to infer, determine, deduce, conclude, speculate, or hypothesize for example, a winning hand, a losing hand, a payout, a buy in, a game beginning, a game ending, etc. The resulting analytics may be provided to casino staff, operations, management, etc. for further analysis, processing, and/or reporting purposes. The analytics may be provided to a software or database system such as a player rating system for storage and/or further analysis. In some configurations, additionally or alternatively, the model output data may be provided to the player rating system and/or casino staff or operations for storage and/or further analysis and/or reporting.

The supply, transfer, and/or transmission of camera data to the one or more models, servers, or computing devices may be in real time or near real time, or the camera data may be intentionally delayed (e.g., a time lag) by a predetermined time interval to reduce risk that camera data being intercepted and/or used for unauthorized purposes, such as advantage play within the casino.

The supply, transfer, and/or transmission of model output data to the one or more servers, processors, computing devices, interpretation engines, etc. may be in real-time or in near real time, or may be intentionally delayed (e.g., a time lag) by a predetermined time interval to reduce the risk that image data or video data could be intercepted and used for unauthorized purposes, such as advantage play within the casino.

In some implementations, the model output data may be maintained or kept on the same network or server, and processed by one or more computing devices or interpretation engines on the same server or network to infer, determine, deduce, conclude, speculate, or hypothesize for example, a winning hand, a losing hand, a payout, a buy in, a game beginning, a game ending, etc.

The following are illustrative examples of the system and method disclosed herein.

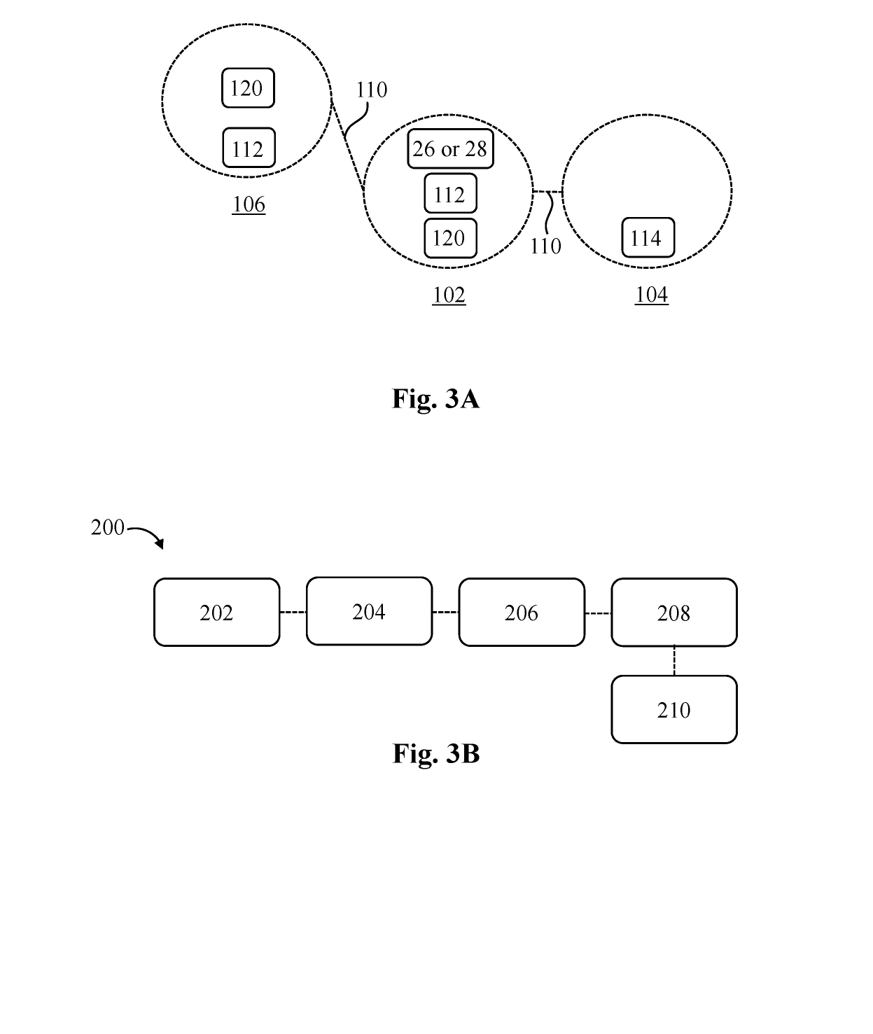

FIG. 3A illustrates an embodiment of a system 100 for generating analytics relating to casino gaming activity at a gaming table in a casino. FIG. 3B illustrates an embodiment of a corresponding method 200 of generating analytics relating to casino gaming activity at a gaming table in a casino utilizing the system of FIG. 3A. Reference is also made to FIG. 1.

The system 100 comprises a first network 102 comprising one or more detection devices 26 or 28 configured to generate camera data. The system 100 comprises one or more computing devices 112 operatively connected to or executed on the first network 102 and configured to execute at least one model 120 on the camera data to generate model output data representative of detected objects and/or activity associated with the casino gaming activity. The system 100 comprises a second network 104 that is separate from the first network 102. The system 100 comprises one or more computing devices 114 operatively connected to or executed on the second network 104. The system 100 comprise a communication interface 110 configured to transmit the model output data from the first network 102 to the second network 104. The one or more computing devices 114 on the second network 104 are configured to process the model output data that is generated on the first network 102 to infer gaming events or performance metrics and to generate analytics relating to the casino gaming activity.

The method 200 comprises a step 202 of analyzing, on a first network 102 that includes one or more detection devices 26 or 28, camera data generated by the one or more detection devices 26 or 28 by running at least one model 112 executed on the first network 102 to generate model output data representative of detected objects and/or activity associated with the casino gaming activity. The first network 102 may be a surveillance network. Therefore, the method 200 may utilize the one or more detection devices 28 that are part of the casino surveillance system. In In the event the first network 202 is a property network (or site network or on-site network) or table network, then the method 200 may utilize the one or more detection devices 26.

The method may include a step or sub step where the at least one model is validated or authenticated on a network prior. This may involve ensuring the model is properly selected from a database for the particular game type. This may take place on any of the networks, for example on the surveillance network, and may take place prior to any of the step, for example prior to the analyzing step.

The method 200 comprises a step 102 of transmitting the model output data from the first network 102 to a second network 104, the second network 104 being a separate network from the first network 102. The second network 104 may be a property network. The transmitting of the model output data from the first network 102 or surveillance network to the second network 104 or property network at the casino may be unidirectional.

In other examples, the second network 104 may be a table network. Only the model output data is transmitted from the first network 102 or surveillance network to the second network 104 or property network. In other words, the raw or un-analyzed camera data from the one or more detection devices on the first network 102 or surveillance network is not transmitted to the second network 104 or property network.

The method 200 comprises a step 206 of processing, by one or more computing devices 114 on the second network 104, the model output data to infer gaming events or performance metrics and generate the analytics relating to the casino gaming activity.

In some implementations, the method 200 may comprise a step 208 of transmitting the model 120 from a third network 106 to the first network 102. The third network 106 may be a cloud network.

It is understood that step 208 may be a first or initial step before any camera data is obtained or processed. For example, this step may occur when a new or updated model is available, when a new game is to be played at a gaming table, at the start of a shift, etc.

During step 208, the model can be transferred manually or automatically from the cloud server 112 to the one or more computing devices or servers in response to a request or instruction to transfer the model. For example, one or more of the servers or computing devices 112, 114 may be informed that a model is available for download from the cloud server 112 and my retrieve the model from the network on which the model is stored. In some configurations, the model may be stored on an intermediatory network and then transmitted to the appropriate network.

In some implementations, the method 200 may comprise a step 210 of transmitting the analytics and/or the model output data to a player rating system employed by the casino and/or to casino staff or operations for further processing or reporting.

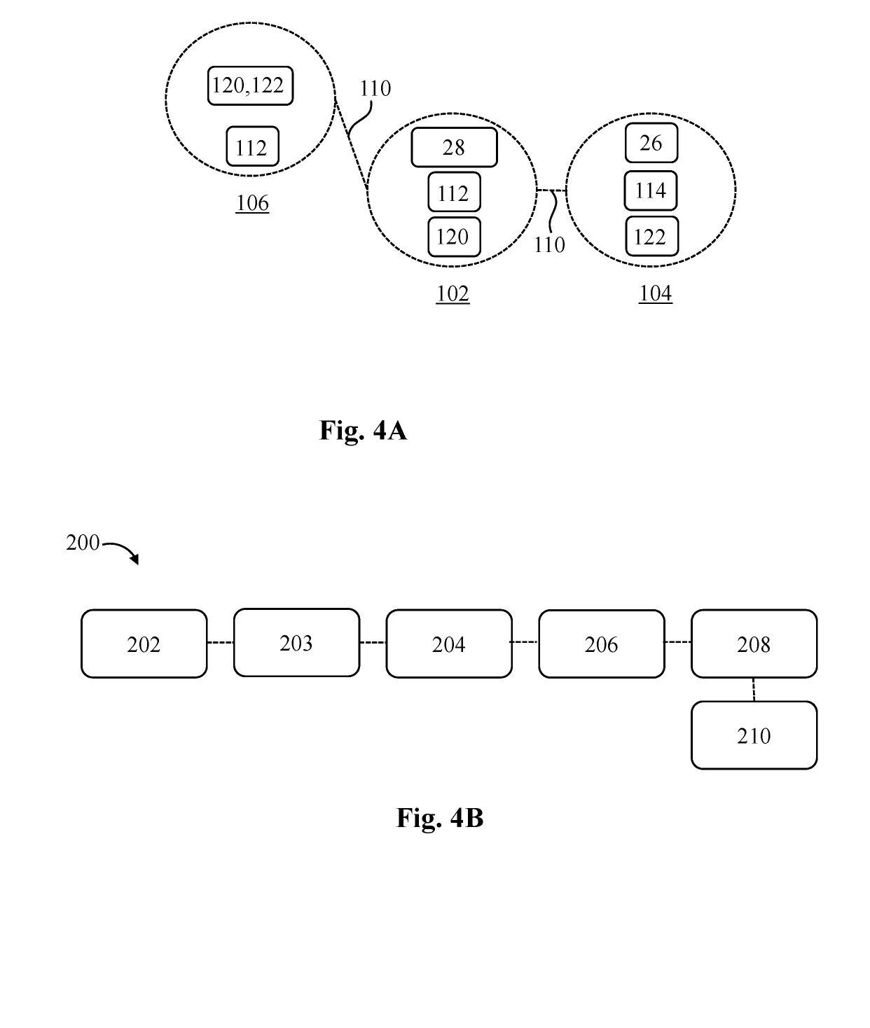

FIG. 4A illustrates an embodiment of a system 100 for generating analytics relating to casino gaming activity at a gaming table in a casino, and FIG. 4B illustrates an embodiment of a corresponding method 200 of generating analytics relating to casino gaming activity at a gaming table in a casino. Reference is also made to the previous figures and disclsoure.

The system 100 of FIG. 4 comprises a first network 102 comprising one or more detection devices 28 configured to generate camera data. The one or more detection devices 28 may be one or more surveillance detection devices 28. The first network 102 may be a surveillance network. The system 100 comprises one or more computing devices 112 operatively connected to or executed on the first network 102 and configured to execute at least one first model 120 on the camera data generated by the one or more detection devices 28 to generate model output data representative of detected objects and/or activity associated with the casino gaming activity. For example, the model output data may be representative of playing cards located at the gaming table.

The system 100 comprises a second network 104 at the casino that is separate from the first network 102. The second network 104 comprising one or more detection devices 26 configured to generate camera data of the gaming table 10. The system 100 comprises one or more computing devices 114 operatively connected to or executed on to the second network 104 and configured to execute at least one second model 122 on the camera data generated by the one or more detection devices 26 to generate model output data representative of detected objects and/or activity associated with the casino gaming activity. The model output data may be representative of gaming chips located at the gaming table.

The system 100 comprises a communication interface 110 configured to transmit the model output data from the first network 102 to the second network 104. The one or more computing devices 114 on the second network 104 may be configured to process the model output data to infer gaming events or performance metrics and to generate analytics relating to the casino gaming activity.

The method 200 comprises a step 202 of analyzing, on a first network 102 that includes one or more detection devices 28, camera data generated by the one or more detection devices 28 by running at least one first model 112 executed on the first network 102 to generate model output data representative of detected objects and/or activity associated with the casino gaming activity. The model output data may be representative of playing cards located at the gaming table. The first network 102 may be a surveillance network.

The method 200 comprises a step 203 of analyzing, on a second network 104 that includes one or more detection devices 26, camera data generated by the one or more detection devices 26 by running at least one second model 122 executed on the second network 104 to generate model output data representative of detected objects and/or activity associated with the casino gaming activity. The model output data may be representative of gaming chips located at the gaming table.

The method 200 comprises a step 204 of transmitting the model output data from the first network 102 to a second network 104 at the casino, the second network 104 being a separate network from the first network 102. The second network 104 may be a property network. The transmitting of the model output data from the first network 102 or surveillance network to the second network 104 or property network at the casino may be unidirectional.

The method 200 comprises a step 206 of processing, by one or more computing devices 114 on the second network 104, the model output data from the first network 102 and the model output data from second network 102 to or interpretation engine to infer, determine, deduce, conclude, speculate, or hypothesize certain gaming events or performance metrics and generate the analytics relating to the casino gaming activity. For example, the method may include combining the model output data from the first network 102 or surveillance network and the model output data from the second network 104 or property network to generate the analytics.

In some implementations, the method 200 may comprise a step 208 of transmitting the first model 120 and the second model 122 from a third network 106 to the first network 102 and the second network 104 respectively. The third network 106 may be a cloud network.

In some implementations, the method 200 may comprise a step 210 of transmitting the analytics and/or the model output data to a player rating system employed by the casino.

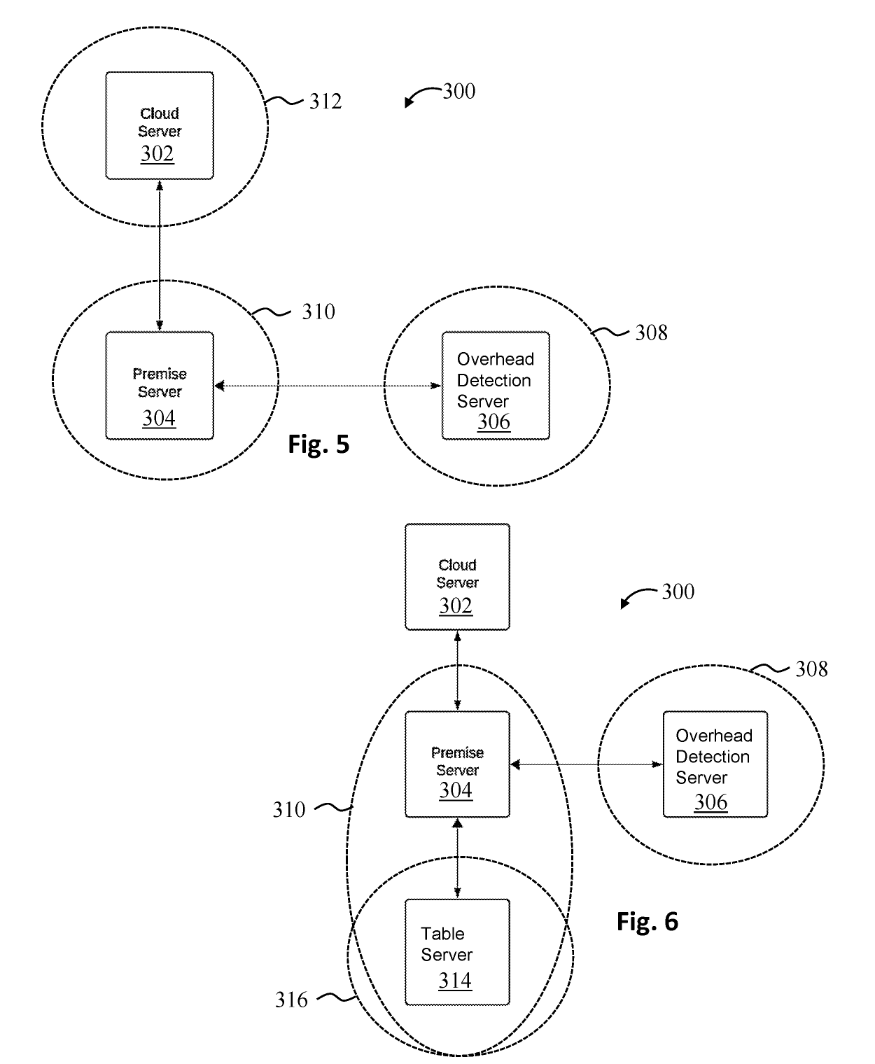

FIG. 5 is a block diagram that depicts exemplary hardware of a system 300 and steps to carry out the method described herein. The system 300 comprises a cloud server 302, a property server 304, and an overhead detection server 306. The cloud server 302 is located on a cloud network 312; the property server 304 is located on the property network 310; and the overhead detection server 306 is located on the surveillance network 308.

The system 300 and/or associated method disclosed herein may utilize one or more models. After the model is created or available on one or more of the servers, the method may include a step of transmitting, communicating, or sending the model from a first server, such as the cloud server 302, to another sever, such as the property server 304 located on the property network 310 at the casino facility. The model can be transferred manually or automatically from the cloud server 302 to the property network 310 or in response to a request or instruction to transfer the model. The model data may contain information regarding game type, number of bet positions, as well as the names and locations of other wagers on the table, commonly called side wagers. Once received from the cloud server 302, metadata related to the model such as imagery of the layout, as well as information related to the number and type of wagering positions can be added and stored on the property server 104. The property server 304 may also verify an integrity of the model and ensure the model is complete (e.g., that all elements of the model are present and in good working order and not corrupt, for example).

After the model is located and available on the property server 304, the method may include a step of transmitting, communicating, or sending the model from the property server 304 on the property network 310 to the overhead detection server 306 located on the surveillance network 308 at the casino facility. The model may be sent to the overhead detection server 306 located on the surveillance network 308 via a secured connection or transferred via a USB or other physical drive to the overhead detection server 306 on the surveillance network 308.

The overhead detection server 306 may contain a computing or processing device for running the model. For example, the overhead detection server 306 may comprise a processing device such as a Neural Processing Unit. During use, for example, when monitoring or observing casino game play at the casino table via the one or more detection devices 28, the overhead detection server 306 may obtain a picture and/or video feed of the gaming table and/or elements on the gaming table (e.g., cards, chips, etc.). The picture and/or video feed data may be compared to or run on or against the model to understand what is taking place on the gaming table. For example, the overhead detection server 306 may correlate data of the image or video feed obtained via the detection device(s) 28 to one or more chips being placed in a particular wager position followed by a card being detected near that position; that all cards are removed from the casino table, etc. This specific information or correlated data can be transmitted to the property server 304 for further analysis. In other configurations, the raw image and/or video data can be sent to another server or network to be compared against the model to generate the correlated data. For example, real time, or slightly delated images and/or video feed can be sent to the property server or property network to be compared against the model.

After the property server 304 receives the correlated data or detected output from the overhead detection server 306, the property server 304 may interpret the information via an interpretation engine running on the property server 304 to generate analytics. For instance, using the example above, if correlated data is sent from the object detection server 306 to the property server 304 that one or more chips are placed in a particular wager position, followed by a card being detected near that position, then the property server 304 can deduce, via the interpretation engine running on the property server 304, that a round of game play has started. Using the example above, in response to correlated data or information sent to the property server 304 from the overhead detection server 306 on the surveillance network 308 that all cards are removed from the casino table, the property server 304 can determine, via the interpretation engine, that the round is over or that game play has ended. The property server 304 may be configured to provide an output or feedback of the analysis in the form of analytics to the appropriate personnel, such as casino operations or management, security, or other interested parties. The interpretation engine may include a deep learning or machine learning algorithm when interpreting the correlated data to improve efficiency and accuracy of the analytics.

In some configurations, an analysis or interpretation engine can also, or can instead, reside on the overhead detection server 306 on the surveillance network 308. This may be the case if the surveillance network 308 is closed and does not permit communication of certain information to other networks like the property network 304 for further analysis. In such a configuration, the analytics can be obtained from the surveillance network 308 and overhead detection server. This may advantageously ensure that the surveillance network 308 remains a black box and information detected by the one or more detection devices 28 cannot be obtained by others for advantage play or other nefarious uses. The results from the analysis or interpretation engine on the overhead detection server 306 on the surveillance network 308 can be sent to the property server 304 or property network 310 for communication or review by casino operations or management staff. For example, using the above example, rather than sending information that one or more chips are placed in a particular wager position, followed by a card being detected near that position to determine that the game play has ended, only information that game play has ended will be communicated to the property server 310. This may help prevent any possibility of sharing information with networks or servers outside of the surveillance network 108 of actual game play activity.

In some configurations, the overhead detection server 306 may send the data or information to the property server for processing and performing the analytics. However, the information may be delayed (e.g., a time lag) to reduce chances of the image or video feed being intercepted by bad actors and used for advantage play at the casino.

Accordingly, these teachings provide a method of generating analytics for casino gaming activity in a casino, the method comprising sending data from a surveillance network 308 at the casino to a property network 310 at the casino. In response to receiving the data from the surveillance network 308, the method comprises a step of interpreting the data with an interpretation engine residing on the property network 310 to generate the analytics about the casino gaming activity. After the analysis is generated on the property network, the method comprises providing the analytics from the property server 310 to casino operations and/or to another server or network. During the comparing step, the overhead detection server 306 correlates the data to the casino gaming activity taking place. The correlated data is sent to the property server 304 to generate the analytics about the casino gaming activity. The model is sent to a cloud server 312, and after the model is in the cloud server 312, the method comprises sending the model to the property server 304 and/or the surveillance server 308.

The method herein comprises sending the model to the surveillance network 308, the surveillance network 308 comprises an overhead detection server 306 comprising one or more overhead cameras 28 that is/are part of a surveillance or security system of the casino, and wherein the method comprising comparing the data obtained from the one or more overhead cameras 28 to the model before the data is sent to the property network 304.

Referring now to FIG. 6, in another example, the system 300 and/or method may use an overhead detection device or camera 28 on the surveillance network 308 that is configured to run the model and transmit one or more images and/or video feed to the property server 304 on the property network 310, like the example disclosed above at FIG. 5.

In addition, one or more images and/or video feed from one or more of the detection devices 26 located at or near the gaming table 10 may be communicated by a table computer or processor 314 to the property server 304. The table computer or processor 314 may be located on the property server 310, or the table computer or processor 314 may be located on its own table network 316. A table network 316 may connect two or more tables in the casino facility and/or other servers.

The table processing unit or server 314 may be a server or processing devices that may or may not have a Neural Processing Unit. Accordingly, in this example, a model can also run on the table processing unit 314, which may be used in conjunction with one or more of the detection devices 26 located at or near the gaming table 10 for detecting and identifying player faces, identifying wagering chips, or other items of interest. In this instance, such data acquired from the table processing unit 314 is transmitted to the property server 304 to combine with the data obtained via the surveillance detection devices 28 on an overhead detection server 306.

In this example, the table processing unit 314 can act as an analysis server to detect chip values while the object detection server 306 used in conjunction with the overhead camera stream 28 would be used for detecting card placement, card values, and currency values. The property server 304 can then combine the information from the overhead detection server 306 and the table computer or processor 314 to obtain an accurate assessment of the game table activity to provide more accurate analytics (e.g., average bet of the player, player profile for the rating system, number of hands dealt by the dealer, table up time, table down time, etc.)

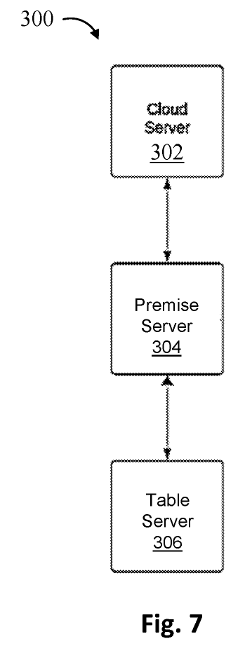

It is understood that in some configurations, in the absence of the overhead camera server 306 or analysis, the table processing unit 314 may perform all the above mentioned analysis in one location. The property server 304 may be configured to provide an output or feedback of the analysis in the form of analytics to the appropriate personnel, such as casino operations or management, security, or other interested parties. This concept is further discussed in FIG. 7.

Referring now to FIG. 7, a model can be sent or transmitted from the cloud sever 302 to the property server 304. Additionally or alternatively, the model can be sent to the table computer or processor 304. The table computer or processor 314 may obtain one or more still images and/or video feeds via the one or more detection devices 26 at the table 10 (FIG. 1). The table computer or processor 314 may transmit the one or more still or video feeds of activity taking place (or not taking place) on the gaming table to the property server 304. The interpretation engine on the property server may interpret the image and/or video feeds and translate the activity (or lack of activity) into specific analytics for evaluation by casino operators or staff (e.g., number of hands dealt per hour, player rating/betting history, etc.).

Additionally, or alternately, the table computer or processor 314 may include a processing unit for interpreting the video or image feed before sending the interpreted information to the property server 304 for further evaluation or processing by an interpretation engine on the property server 304.

The interpreted information may be output from the property server 304 and/or the cloud server 302 (after being passed to the cloud sever) to interested parties like casino supervisors or operations.

Improvements to the system 300 and/or method may be needed from time to time. In addition, new elements might be requested in the model. In this instance, reference imagery would be acquired at the casino level and sent via an electronic method or delivered via a portable storage medium. Once received, a new model is created with the reference imagery and transferred as described herein.

The system and/or method may function with a cloud server 302 or via a method, in which the files are input into the system via digital transmission with a manual input of the file into the property server or analysis server.

In another embodiment, all imagery, casino specific, and casino non-specific, might be stored on the property server 304 or analysis server 306. If a new table layout is intended to be used, the casino staff would input the imagery for the layout into the property server 304 or analysis server 306.

As used herein, a server may comprise one or more computers, processors, and/or processing devices. A server may be configured to compute, process, determine, exchange, compare, and/or share information, data, and/or computing resources with other components or clients of the system. A server may include one or more processors and one or more memories, such as hard drives, random access memory (RAM), or other non-transitory computer-readable storage media, for storing data, executing program instructions, and performing analysis and interpretation of data.

A server may store and execute software, firmware, algorithms, rules, lookup tables, interpretation engines, machine learning models, deep learning models, or combinations thereof to perform one or more of the method steps and/or functions described herein. A server may be programmed or reprogrammed. A server may be programmed or reprogrammed using software instructions, algorithms, code, lookup tables, or models to execute analytics, detection, correlation, or interpretation functions according to these teachings. In some embodiments, a server may be updated over time as data is received from one or more models and/or detection devices to improve efficiency, accuracy, or performance, including through automated learning processes such as machine learning or deep learning and/or through manual updates performed by software engineers.

A server may be implemented as a physical computing device, a virtualized computing instance, a distributed computing system, or any combination thereof. In some embodiments, the server may include specialized processing hardware, such as a graphics processing unit (GPU), neural processing unit (NPU), or other accelerator, to support image processing, video processing, machine learning, or deep learning operations.

As used herein, a network may comprise one or more communication infrastructures and an arrangement of interconnected devices, such as servers, processors, or computing devices, that enable electronic communication and data transfer between two or more devices, servers, or systems. A network may be configured to allow the exchange or sharing of resources, including data, images, video feeds, files, models, analytics, and/or other information. Communication within the network, or between networks, may occur via wired communication links, wireless communication links, or combinations thereof, and may utilize one or more communication protocols.

Information may be shared or transferred between or amongst devices or servers physically, such as using cables or portable storage media (e.g., USB drives), and/or wirelessly using available wireless technologies (e.g., Wi-Fi, Bluetooth, or other wireless standards). Networks may be configured as local networks, private networks, isolated networks, surveillance networks, property networks, cloud networks, or interconnected networks, and may include access control mechanisms that restrict or permit communication between devices or between networks. In some embodiments, a network may support unidirectional or bidirectional communication, may be segmented into sub-networks, and may be configured to limit access to data or devices connected thereto in accordance with security, regulatory, or operational requirements.

As used herein, to build or create a model, one or more images or electronic representations of one or more casino gaming tables and/or elements may be generated, created and/or acquired. One or more servers (e.g., a cloud server, property server, overhead detection server, table computer or processor, etc.) may include one or more processors and/or graphics processing units (GPU’s) that are configured to generate, train, build, and/or update a model.

Images or electronic representations of the one or more gaming elements may be transmitted to or retrieved by a server for use in building or updating the model, and/or a completed model may be transmitted to one or more servers for storage and/or deployment, including to a property server, overhead detection server, table computer or processor, or combinations thereof.

The images or electronic representations of the one or more gaming elements may be created, for example, by scanning one or more of the gaming elements with a camera or other scanning device. The scans may be a 2D or 3D representation. The images or electronic representations (e.g., CAD or other build files) may be obtained from a casino, table manufacturer, or vendor.

The images or electronic representations can be sent to or retrieved by a server for use in building the model and/or a completed model may be transmitted to one or more servers for storage and/or deployment, including to a property server, overhead detection server, table computer or processor, or combinations thereof.

In some configurations, a preliminary or generic model may be built and/or stored in one or more of the servers disclosed herein. A preliminary or generic model may be a model of one or more of the elements associated with the casino or gaming table but does not include the actual table layout. For example, a preliminary or generic model may include an electronic depiction or representation of one or more elements that typically do not change frequently, such as the playing cards, the gaming chips, the chip tray, the discard rack, the cut card, etc.

One or more gaming tables having different layouts may utilize a preliminary or generic model. This may advantageously speed up the process of building a model in that only data of a table layout needs to be produced and/or obtained from the vendor or manufacturer of the table layout when a new layout is to be used. This new table layout may then be combined or merged with the existing electronic depictions or representations of the gaming elements that did not change. This may save time and/or processing power to complete a model when a majority of the table elements are generic or already known and do not change.

In other embodiments, a preliminary or generic model may include a table layout and only an updated table element is added, such as if a casino includes a new gaming chip, playing card, etc., as may be the case for a special or promotional event for example, and the model may be updated accordingly.

A model may be created, trained, built, uploaded, and/or stored on one or more servers or networks. For example, a model may be built or created and stored on a cloud server, a property server, an overhead detection server, a table computer or processor, or another server. The model may be built or created on another server, and then uploaded or sent to a cloud server, property server, table computer or processor, overhead detection server, or any combination thereof. The model may be built or created on a server and not sent or transferred to any other server. For example, the model may be built or uploaded to the cloud server or premise sever or overhead detection server and operate on the cloud or premise or overhead detection server without being transferred to another server. The model may be transferred or sent to or between other servers via electronic communication of the networks on which the particular server(s) is located.

Model data in the model may contain information regarding game type, number of bet positions, identifiers and locations of additional wagers on the gaming table, commonly referred to as side wagers. After the model is received from the cloud server, metadata associated with the model, such as imagery of the layout, as well as information related to the number and type of wagering positions, can be added and stored on the property server. The property server may also verify an integrity of the model and ensure the model is complete (e.g., that all elements of the model are present and in good working order and not corrupt, for example).

After the model is located and available on the property server, the method may include a step of transmitting, communicating, or sending the model from the property server on the property network to the overhead detection server located on the surveillance network 108 at the casino facility. The model may be transmitted to the overhead detection server located on the surveillance network via a secured connection or transferred via a USB or other physical drive to the overhead detection server on the surveillance network.

In an embodiment, in or during operation of the system and method, one or more models are delivered to, or reside on, a casino on-property network (e.g., a property network) that is separate and distinct from a surveillance network. One or more selected models may be transferred, automatically or manually, into the surveillance network and installed on an analysis server on the surveillance network that has access to one or more camera feeds from one or more surveillance detection devices that are part of a casino surveillance or security system and are located on a surveillance network. The analysis server is configured to execute the model (e.g., the machine learning model and/or the deep-learning model) on live or near-live video streams from the one or more detection devices and generate model output data. An example of model output date is the presence of a chip at a particular wager position, a detected card value at a given location, or identification of a player at a specific seat. The resulting model output data is then transmitted from the analysis server on the surveillance network to the property server. The property server may include an interpretation engine, which interprets the output data to infer higher-level game events and performance metrics such as a gaming event or round has started or ended, bet wager amounts or information, hands per hour, player betting behavior, etc., thereby generating analytics related to the casino gaming activity taking place or has taken place. After the analytics are generated on the property network, the property server provides the analytics to casino operations, management, and/or other authorized casino personnel for monitoring, analysis, and operational decision-making.

In an embodiment, in or during operation of the system and method, one or more models are delivered to or reside on a casino on-property network (e.g., a property network) that is separate and distinct from a surveillance network. One or more image or video camera feeds from one or more detection devices on a surveillance network are transmitted to the property network. An analysis server on the property network is configured to execute the deep-learning model on live or near-live video streams from the one or more detection devices and generate model output data. An example of model output data is the presence of a chip at a particular wager position, a detected card value at a given location, or identification of a player at a specific seat. The resulting model output data generated by the analysis server on the property network is then provided to an interpretation engine on the property network, which interprets the output data to infer higher-level game events and performance metrics such as a gaming event or round has started or ended, bet wager amounts or information, hands per hour, player betting behavior, etc., thereby generating analytics related to the casino gaming activity taking place or has taken place.

The system and/or method may have or employ more than one model. For example, one model (a first model) may reside on the overhead detection server and configured to analyze or correlate camera images/video data of one or more elements such as card values, suites, currency values, etc. Another model (a second model) may reside on the table or premise sever and configured to analyze or correlate camera images/video data of a player’s face, chip values or chip stacks, etc.

In some embodiments, the method includes obtaining or generating a plurality of models associated with different gaming elements at a gaming table. A first model may comprise an electronic representation of one or more playing cards, including card values and suits, for use at the gaming table, and a second model may comprise an electronic representation of one or more gaming chips, including chip denominations and stack configurations, for use at the gaming table. The first model may be transmitted from a network, such as a cloud network or a property network, to a surveillance network, where the first model is made available to an overhead detection server that receives data generated by one or more overhead surveillance detection devices. Data obtained from the one or more overhead surveillance detection devices can be compared with the first model at the surveillance network to identify or correlate playing card information. The second model may be transmitted from a network, such as the cloud network, to the property network, where the second model is made available to a table network or table computer or processor or property server. Data obtained from one or more detection devices located at or near the gaming table, which may include table-mounted cameras, is compared with the second model to identify or correlate gaming chip information. The compared or correlated data derived at the surveillance network and the compared or correlated data derived at the property network may be interpreted by an interpretation engine executing on the property server or table computer or processor or elsewhere to generate analytics relating to the casino gaming activity.

This analyzed data from the one or more models can be provided or fed into one or more interpretation engines for interpreting or determining the game play activity or operational events that are or are not taking place. Such multi-model configuration may be applied or implemented in the embodiment illustrated and described at FIG. 7.

In some configurations, multiple models may reside on and/or be executed by a single server. For example, different gaming tables may have different table layouts, and corresponding models may be created for and associated with each layout. The teachings herein allow to run different models on the same or various servers depending on the situation.

In some configurations, one or more models may be transmitted from the cloud server on the cloud network to the overhead detection server on the surveillance network. In such configurations, communication may be 1-way or unidirectional, such that the overhead detection server and/or the surveillance network is configured to receive model data from the cloud server or cloud network without transmitting data back. This arrangement may help preserve the integrity and security of the surveillance network by reducing the risk of unauthorized data transfer from the surveillance network to external networks or servers.

As used herein, an interpretation engine may comprise one or more software modules, algorithms, rule sets, or executable instructions configured to receive data or model output data, and interpret such data to determine casino gaming activity and generate analytics. The interpretation engine may execute on one or more servers, such as a property server, table computer or processor, cloud server, or overhead detection server, and may utilize one or more processors and memories of the server on which it resides.

The interpretation engine may be configured to analyze the data or model output data received from one or more analysis servers and/or detection devices to identify, infer, or determine one or more game states, events, or conditions, including but not limited to a start of a game round, an end of a game round, wager placement, wager resolution, dealer activity, player activity, table utilization, or idle states. In some embodiments, the interpretation engine applies logical rules, heuristics, thresholds, or temporal relationships between detected events in the model output data to derive the analytics.

In some configurations, the interpretation engine may further incorporate or interact with one or more machine learning models or deep learning models to improve accuracy, robustness, or adaptability of the analytics. For example, the interpretation engine may process outputs generated by object recognition models identifying playing cards, gaming chips, betting regions, currency, or player actions, and may correlate such outputs over time to determine casino gaming activity.

In certain embodiments, the interpretation engine resides on a property network that is separate from a surveillance network, and receives only data or model output data transmitted from the surveillance network without receiving raw image or video data. This configuration enables generation of analytics while preserving security, regulatory compliance, and isolation of surveillance systems, and prevents unauthorized access to surveillance imagery.

The interpretation engine may output the generated analytics to casino operations systems, reporting systems, player rating systems, management interfaces, or other authorized systems or personnel. The interpretation engine may be updated, configured, or retrained over time to accommodate new table layouts, game rules, models, or operational requirements.

As used herein, analytics may include game play and round level analytics. Such analytics may include: start of a game round, end of a game round, number of rounds per unit time (minute/hour/shift/day), game state transitions (idle → active → payout → reset), detection of incomplete or aborted rounds, time duration of each round, or any combination thereof.

As used herein, analytics may include dealer performance and operational metrics. Such analytics may include: number of hands dealt per hour / shift / day, dealer efficiency metrics (hands per minute), dealer idle time, dealer changeover events, dealer break start and end times, compliance with dealing procedures, detection of irregular dealer actions, or any combination thereof.

As used herein, analytics may include table utilization analytics. Such analytics may include table uptime (open and available for play), table downtime (closed, idle, or unavailable), time between rounds, peak utilization periods, underutilized tables, table availability across shifts, or a combination thereof.

As used herein, analytics may include player betting and wager analytics. Such analytics may include bet placement events, bet timing relative to game state, bet amount per wager, average bet per round, total wagered amount per session, win/loss per round, win/loss per hour, shift, or day, betting trends over time, identification of side wagers placed, identification of betting regions used, or a combination thereof.

As used herein, analytics may include chip, card, and/or currency analytics. Such analytics may include chip denomination identification, chip stack height and value estimation, total chips wagered per betting region, currency value detection during buy-in or cash-out, card value identification, card suit identification, card placement relative to betting regions, detection of card removal from the table, detection of shoe depletion or reshuffle events, or any combination thereof.

As used herein, analytics may include player identification and rating analytics. Such analytics may include player presence at a table, player arrival and departure times, player session duration, player betting profile, player average wager, player volatility (bet variation), player rating metrics, integration data for loyalty or player rating systems, or a combination thereof.

As used herein, analytics may include surveillance, security and compliance analytics. Such analytics may include detection of anomalous gameplay behavior, detection of irregular betting patterns, detection of unusual chip movement, detection of potential advantage play indicators, detection of rule violations, detection of suspicious dealer-player interactions, audit logs of gameplay activity, regulatory compliance metrics.

As used herein, analytics may include any information derived from monitored casino gaming activity that is useful for operational analysis, security, regulatory compliance, player rating, or business decision-making.

The analytics may include information relating to player betting behavior, which may be used in connection with a player rating system. In some embodiments, the analytics system and/or method according to these teachings may be incorporated into an existing player rating system or implemented as part of a new player rating system for a casino.

The analytics system and/or method of these teachings may further be used to evaluate and/or understand utilization of gaming tables, including periods during which a gaming table is operational or non-operational, and to generate performance metrics, such as a number of hands dealt by a dealer over a defined time period or dealer activity patterns during a shift, number of breaks a dealer takes during a shift, etc.

In some embodiments, the analytics system and/or method may implement chip recognition (e.g., identification of gaming chip denominations using one or more detection devices), currency detection (e.g., identification of currency values during buy-in and/or betting), and/or player identification techniques, such as facial or body recognition or other identification approaches, subject to applicable regulatory and operational requirements.

As used herein, machine learning refers to a class of computational techniques in which a system is configured to learn patterns, relationships, or representations from data and to improve performance on a task without being explicitly programmed for every possible scenario. A machine learning model may be trained using labeled data, unlabeled data, or a combination thereof, and may include supervised learning, unsupervised learning, semi-supervised learning, or reinforcement learning techniques. Machine learning models may be configured to perform tasks such as classification, detection, recognition, prediction, correlation, or decision making based on input data.

In the context of the systems and methods described herein, machine learning may be used to process data obtained from one or more detection devices to identify or recognize objects, patterns, or events associated with casino gaming activity, including playing cards, card values or suits, gaming chips, chip denominations or stacks, currency, betting regions, dealer actions, player actions, or game states. A machine learning model may be trained using historical data, reference imagery, simulated data, or live data collected from gaming environments, and may be updated or retrained over time to improve accuracy, robustness, or adaptability to new table layouts, gaming elements, or operational conditions.

As used herein, deep learning refers to a subset of machine learning techniques that utilize multi-layered computational models, such as neural networks, to learn hierarchical representations of data. A deep learning model may include one or more layers of interconnected nodes configured to extract increasingly abstract features from input data, such as image data, video data, or other sensor data. Deep learning models may be trained using labeled training data, unlabeled data, or combinations thereof, and may employ techniques such as convolutional neural networks, recurrent neural networks, transformer architectures, or other neural network architectures. In the systems and methods described herein, deep learning may be employed to analyze data obtained from one or more detection devices to identify, classify, or recognize elements associated with casino gaming activity, including but not limited to playing cards, card values or suits, gaming chips, chip denominations or stacks, currency, betting regions, dealer actions, player actions, or game states. Deep learning models may be trained using reference imagery, historical gameplay data, simulated data, or live data collected from casino environments, and may be updated or retrained over time to improve accuracy, resilience to environmental variation, and adaptability to different table layouts, gaming elements, or camera viewpoints.

The method disclosed herein may be used to monitor, understand, predict, review, analyze, decipher, observe, and/or evaluate operations and/or game play at one or more casino gaming tables. The method may provide insights or generate analytics relating to player betting behavior, utilization of gaming tables, and/or casino performance metrics, including, for example, the number of hands dealt by a dealer over a defined time period, timing and duration of dealer or employee breaks, table uptime during which a gaming table is open and available for game play, and table downtime during which the gaming table is closed or unavailable for game play.

The method may include one or more recognition components, such as chip recognition (e.g., identifying gaming chip denominations using one or more detection devices), card recognition (e.g., identifying a value and suit of a playing card and determining placement of the playing card relative to regions of interest on the gaming table), bet placement recognition (e.g., determining whether, when, and in what amount a wager is placed in a betting region during gameplay), and/or player identification techniques.

In some embodiments, player identification techniques may include facial recognition or other body identification approaches for identifying a player and/or detecting potentially unauthorized or anomalous activity, subject to applicable regulatory and operational constraints.

The analytics system 100 and/or method may include machine learning and/or deep learning capabilities. For example, a machine learning and/or deep learning model may be trained to learn or recognize relative dimensions, shapes, and visual patterns of gaming elements, such as playing cards or gaming chips, as viewed from different perspectives, including a top-down view captured by an overhead detection device and a side view captured by a detection device positioned at or near the gaming table. Such analysis may enable automated generation of information that has traditionally been recorded manually by casino staff or operators. The machine learning and/or deep learning models may be implemented on one or more of the servers or networks described herein, including, for example, a cloud server, a property server, a table computer or processor, an overhead detection server, or any combination thereof.

Improvements to the system and/or method may be needed from time to time. In addition, new elements might be requested in the model. In this instance, reference imagery would be acquired at the casino level and sent via an electronic method or delivered via a portable storage medium. Once received, a new model is created with the reference imagery and transferred as described herein.

The system and/or method may function with a cloud server or via a method, in which the files are input into the system via digital transmission with a manual input of the file into the property server or analysis server.

In another embodiment, all imagery, casino specific, and casino non-specific, might be stored on the property server or analysis server. If a new table layout is intended to be used, the casino staff would input the imagery for the layout into the property server or analysis server.

In some configurations: only inferred game-state information is transmitted from the surveillance network to the property network, and raw image or video data is not transmitted; the analytics include determining at least one game state selected from: start of a round, end of a round, payout event, dealer change, or table idle state; the surveillance network is isolated from external networks and prevents outbound transmission of player-visible gameplay information; the analytics are provided to a player rating or loyalty management system; the machine learning model outputs a confidence score associated with detected gaming activity.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. A method of generating analytics relating to casino gaming activity at a gaming table in a casino, the method comprising:
analyzing, on a surveillance network that includes one or more detection devices, camera data generated by the one or more detection devices by running at least one model executed on the surveillance network to generate model output data representative of detected gaming objects and/or activity associated with the casino gaming activity;
transmitting the model output data from the surveillance network to a property network at the casino, the property network being a separate network from the surveillance network; and
processing, by one or more computing devices on the property network, the model output data to infer gaming events or performance metrics and generate the analytics relating to the casino gaming activity.

2. The method according to claim 1, wherein the camera data is not transmitted from the surveillance network to the property network.

3. The method according to claim 1, wherein the one or more detection devices are one or more overhead cameras that are part of a surveillance system at the casino.

4. The method according to claim 1, wherein the model comprises an electronic representation of the gaming table and/or one or more gaming elements used at the gaming table, and wherein the model comprises machine learning and/or deep learning.

5. The method according to claim 1, wherein the method comprises transmitting the model from a cloud server to the surveillance network.

6. The method according to claim 1, wherein at least one second model is executed on the property network, the property network further comprises one or more detection devices, and the method comprises analyzing, on the property network, camera data generated by the one or more detection devices on the property network by running the at least one second model residing on the property network to generate second model output data representative of detected objects and/or activity associated with the casino gaming activity.

7. The method according to claim 6, wherein the method comprises combining the model output data from the surveillance network and the model output data from the property network to generate the analytics.

8. The method according to claim 6, wherein the model output data from the property network is representative of gaming chips located at the gaming table, and the model output data from the surveillance network is representative of playing cards located at the gaming table.

9. The method according to claim 6, wherein the one or more detection devices on the property network are one or more cameras that are mounted to or integrated with one or more of elements selected from a group consisting essentially of: a table sign, a chip tray, a card shoe, an elevated table or tower sign, a discard rack.

10. The method according to claim 9, wherein the one or more detection devices are one or more overhead cameras that are part of a surveillance system at the casino.

11. The method according to claim 1, wherein the at least one model is executed on the surveillance network and/or the property network using hardware accelerators selected from the group consisting of GPUs, TPUs, and FPGAs.

12. The method according to claim 1, wherein the at least one model is validated or authenticated on the surveillance network prior to the analyzing step.

13. The method according to claim 1, wherein the at least one model is updated over time based on previously generated model output data

14. The method according to claim 1, wherein the transmitting of the model output data from the surveillance network to the property network at the casino is unidirectional.

15. A non-transitory computer-readable medium storing instructions that, when executed by one or more computing devices, cause the one or more computing devices to perform the method according to claim 1.

16. A method of generating analytics relating to casino gaming activity at a gaming table in a casino, the method comprising:
analyzing, on a first network that includes one or more detection devices, camera data generated by the one or more detection devices by running at least one model executed on the first network to generate model output data representative of detected objects and/or activity associated with the casino gaming activity;
transmitting the model output data from the first network to a second network at the casino, the second network being a separate network from the first network; and
processing, by one or more computing devices on the second network, the model output data to infer gaming events or performance metrics and generate the analytics relating to the casino gaming activity.

17. The method according to claim 16, wherein the camera data is not transmitted from the first network to the second network.

18. The method according to claim 16, wherein at least one second model is executed on the second network, the second network comprises one or more detection devices, and the method comprises analyzing, on the second network, camera data generated by the one or more detection devices on the second network by running the at least one second model residing on the second network to generate second model output data representative of detected objects and/or activity associated with the casino gaming activity.

19. A system for generating analytics relating to casino gaming activity at a gaming table in a casino, the system comprising:
a first network comprising one or more detection devices configured to generate camera data of the gaming table;
one or more computing devices operatively connected to or executed on the first network and configured to execute at least one model on the camera data to generate model output data representative of detected objects and/or activity associated with the casino gaming activity;
a second network at the casino that is separate from the first network;
one or more computing devices operatively connected to the second network; and
a communication interface configured to transmit the model output data from the first network to the second network;
wherein the one or more computing devices on the second network are configured to process the model output data to infer gaming events or performance metrics and to generate analytics relating to the casino gaming activity.

20. The system according to claim 19, wherein at least one second model is executed on the second network, the second network comprises one or more detection devices, and the method comprises analyzing, on the second network, camera data generated by the one or more detection devices on the second network by running the at least one second model residing on the second network to generate second model output data representative of detected objects and/or activity associated with the casino gaming activity.
